(19) United States
(12) Patent Application Publication
(10) Pub. No.: US 2013/0297488 A1
(43) Pub. Date: Nov. 7, 2013

(54) SYSTEM, METHOD, SERVICE AND COMPUTER READABLE MEDIUM FOR TAKING AND PROCESSING PAPERLESS MORTGAGE LOAN APPLICATIONS

(71) Applicant: PGB Solutions, Inc., (US)

(72) Inventors: Iavor BOYANOV, Burlingame, CA (US); Iordan GAVAZOV, San Carlos, CA (US)

(21) Appl. No.: 13/830,812

(22) Filed: Mar. 14, 2013

Related U.S. Application Data
(60) Provisional application No. 61/623,397, filed on Apr. 12, 2012.

(51) Int. Cl. G06Q 40/02

(52) U.S. Cl. CPC G06Q 40/02
USPC 705/38; 705/35

(57) ABSTRACT

A system, service, method, and computer program product is described that allows borrowers to fill-in, sign and submit mortgage loan applications and custom disclosures directly from tablet computers without the need of paper. The signed forms and data are securely transferred from the tablet computers to the loan agent's LOS software and imaging system.

### CROSS REFERENCE TO RELATED APPLICATIONS

The present application claims the benefit of U.S. provisional application No. 61/623,397, filed on Apr. 12, 2012, the contents of which are hereby incorporated by reference.

### FIELD OF THE INVENTION

The present invention is generally related to systems and methods to automate mortgage loan applications.

### BACKGROUND OF THE INVENTION

The mortgage loan origination process has evolved greatly in the last 20 years by the use of Loan Origination Systems (“LOS”) software to keep track of loan applications and provide functionality to cover almost every aspect of the process. Filing cabinets have been replaced by electronic document storage solutions (“Imaging Systems”). Many steps that in the past have required manual labor are now automated or irrelevant.

Despite many advances in automation, conventional mortgage loan processes have more steps than desired and are not truly paperless. Referring to FIG. 1, the very first step, however, taking of the loan application, is still a manual paper based process. Loan applications can be taken by a mortgage lender's or mortgage broker's representative (“Loan Agent”) in person, by phone, or through a website application. In all cases, the loan agent provides a paper loan application form, along with other custom mortgage disclosures and provides these to the borrower, either in-person, via fax, mail, or e-mail. Some or all paper forms are either blank or have data pre-printed on them. The borrower has to sign these documents and return them to the loan agent either in-person, via fax, mail, or e-mail. If he chooses to e-mail the document, he will also have to use a scanner to convert them to an electronic format. Once the loan agent receives the signed documents, he has to process them and make sure the loan data exists in his LOS, and that the signed documents are stored in his imaging system. If data was filled-in by the borrower on the loan application and/or other forms, the loan agent will have to manually input this data in his LOS. If the loan application and other forms were not received in an electronic format, the loan agent will have to use a computer scanner to convert them to such. In all cases the loan agent will have to manually import the electronic document in his imaging system.

Thus, the process of taking a loan application can be time consuming and error prone because of the number of steps involved in completing it. Moreover, in the case of documents being sent via e-mail between borrowers and loan agents, there is a chance that borrowers' private data may become exposed and available on the public Internet unless the users take extra steps to protect it (since e-mail is an unsecured delivery method by default).

What is needed, therefore, is a method that allows borrowers to fill-in, sign and submit loan documents without the use of paper to effectively eliminate the potential extra steps of printing, scanning, mailing, LOS data entry, and to ensure data is delivered in a secured way.

### SUMMARY OF THE INVENTION

A system, method, service, and computer program product is disclosed that allows borrowers to fill-in, sign, and submit mortgage loan applications and custom disclosures directly from tablet computers without the need of paper. The signed forms and data are securely transferred from the tablet computers to the loan agent's Loan Origination System (LOS) software and imaging system. During that process, data is validated and an appropriate response is presented to either borrowers or loan agent. Additional functionality is available to provide the ability for loan agents to perform some loan processing directly from the tablet computer without the need to access the LOS software. The use of paper is completely eliminated and with that is eliminated the need for printing, scanning, and dual data input. Private data is stored securely on the tablet computers and is not transferred in unsecured ways, therefore eliminating the risk of exposure to the Internet. The process of taking a mortgage loan application is streamlined and reduced to only a few steps.

### BRIEF DESCRIPTION OF THE DRAWINGS

FIG. 1 is a block diagram illustrating a paper based process of the prior art for taking a mortgage loan application, including all the potential steps involved in printing, scanning, faxing, and duplicate data input.

FIG. 2 is a block diagram providing an overview of an embodiment of a mobile lending service in accordance with an embodiment of the present invention

FIG. 3 illustrates functionality available within a mobile borrowing module of the present invention, intended for use by borrowers in accordance with an embodiment of the present invention.

FIG. 4 illustrates functionality available within a mobile lending module of the present invention, intended for use by the loan agent in accordance with an embodiment of the present invention.

FIG. 5 is a flowchart of backend processing and validation that occurs in accordance with an embodiment of the present invention.

FIG. 6 illustrates aspects of functionality available within a mobile lending website for use by loan agents, as well as their supervisors, in accordance with an embodiment of the present invention.

FIG. 7 is a screen snapshot of the user interface that provides a visual clue as to how a borrower can sign a loan application on a tablet computer in accordance with an embodiment of the present invention.

FIG. 8 is a screen snapshot of a loan application form as presented to the borrower on a tablet computer in accordance with an embodiment of the present invention.

FIG. 9 is a screen snapshot of commands available for a particular loan on the mobile lending module, outlining the additional functionality available to the loan agent in accordance with an embodiment of the present invention.

FIG. 10 is a snapshot of the “tablet settings” screen on a mobile lending website that allows a loan agent or a supervisor to customize the mobile borrower and mobile lender and modules in accordance with an embodiment of the present invention.

FIG. 11 is a snapshot of the imaging system included in the mobile lending website displaying a document that has been filled-in, signed and submitted from a tablet computer in accordance with an embodiment of the present invention.

### DETAILED DESCRIPTION

### I. Overview of Mobile Lending Service

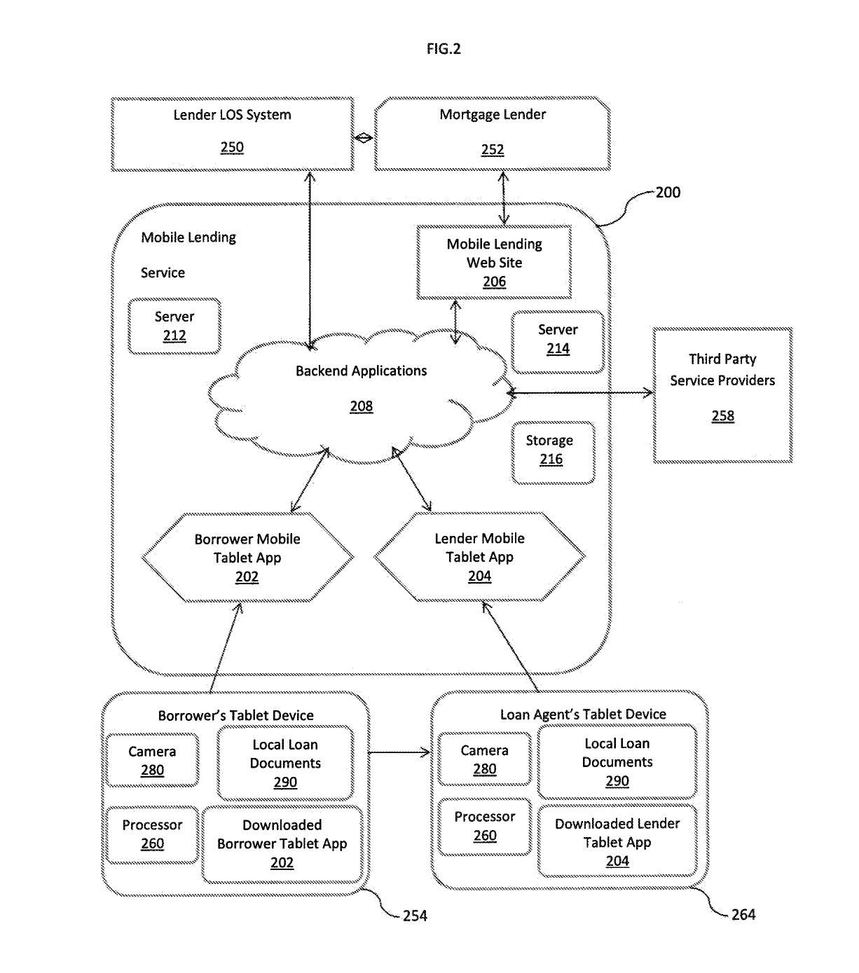

FIG. 2 is a high level overview of a mobile lending service 200 in accordance with an embodiment of the present invention. The mobile lending service 200 generally corresponds to a commercial product known as “LenderMobile” that is offered by PGB Solutions, Inc., the assignee of the present invention. LenderMobile is the name of a mobile lending solution for the mortgage industry that helps borrowers, realtors, and loan agents to save time and increase productivity. LenderMobile allows borrowers and loan agents to fill-in, sign and submit mortgage loan applications and/or other mortgage forms from a tablet computer without the use of paper. LenderMobile provides loan agents with the ability to present custom mortgage forms and documents to their borrowers. In addition, it allows loan agents with the convenience to perform certain loan processing tasks, usually associated with Loan Origination Systems (“LOS”) software, directly from a tablet computer. Mortgage lenders and/or mortgage brokers, and their loan agents are provided with the ability to present a custom branded tablet application to their customers. Realtors also benefit from being given real time access to loan status.

The mobile lending service 200 is part of a larger application environment in which the mobile lending service 200 may access a lender's LOS system 250 and Mortgage Lender System 252. The mobile lending service 200 is implemented as software modules that may, for example, be stored in a non-transitory memory storage (not shown) of a server-based system having one or more mobile lending servers 212, 214 to support a website, web portal, and backend applications, where each server includes at least one processor and a memory. Additional data storage 216 may be provided to store documents, templates, and other information. Conventional communication interfaces and server support for mobile wireless communication with client mobile devices and support for a website is provided.

Individual borrowers access the mobile lending service 200 via a mobile device 254, such as a tablet computing device having a processor 260, display touch screen 270 and an optional camera 280. An exemplary tablet computing device is an iPad™ tablet computer from Apple Computers of Cupertino, Calif.; however, more generally, other types of tablet computing devices may be used as well, including touch screen devices having other screen formats different than an iPad™ such as mini tablet computers and hybrid devices. Loan agents may also access the system via a mobile tablet computing device 256, such as a tablet computer, with an iPad™ being an exemplary device. Web-based access may also be provided for a loan agent to review documents. The system may also be integrated with third party service providers 258 to support individual features as described below in more detail.

In one embodiment, the mobile lending service 200 includes two tablet computer applications (modules), a mobile borrower module 202 and a mobile lender module 204. The mobile lending service 200 includes a mobile lending website 206 and associated servers (not shown), and a set of backend applications 208 for processing data as well as validation and transfers.

The mobile lending service 200 includes hardware such as support servers, data storage, computer processors, and memory associated with the mobile lending web site 206, and any necessary hardware support for the backend applications 208. Additionally, it will be understood that, if desired, some portions of the backend applications 208 may be supported via cloud-based applications.

The mobile borrower module 202 (also known in a commercial embodiment as “BorrowerMobile”) is a tablet application for borrowers. It is intended for use by borrowers to apply for a mortgage loan and to check the status of a loan application, as well as to review and provide related documents.

The mobile lender module (also known in a commercial embodiment as “LenderMobile+”) 204 is a tablet application for loan agents. It is intended for use by loan agents to take and process mortgage loan applications.

The tablet computer applications 202 and 204 may be implemented in accordance with the manner in which other types of tablet computer applications are implemented, such as providing software modules and/or browser elements that are downloadable to an individual tablet computing device 254 or 256 from the mobile lending website 206. An individual tablet computing device may also receive loan document templates for the forming of local loan documents 290 that are stored in the memory (not shown) of an individual tablet computing device. That is, the a tablet computing device has the template documents required for loan application and may also store the executed loan documents in local memory until they are uploaded or otherwise transmitted via the backend applications 208 for further processing by a mortgage lender 252 or Lender LOS system 250.

In one embodiment, the tablet computer applications for the mobile borrower module 202, and the mobile lender module 204, provide local storage 290 of loan forms and data on the tablet computing devices, and provide the majority of functions on the tablet computing device such that a wireless connection to the backend is necessary only for key steps, such as data submission, updates, and the like. However, as is well known in the software field, variations in the partitioning of software functionality between a backend application and a client device are possible based on how much of the software functionality resides on the client device and how much in other parts of the backend application. Thus, it will be understood that in an alternate implementation, more of the functionality could reside in the backend, if desired.

The mobile lending website module 206 (known in a commercial embodiment as “LenderMobile.com”) is a website intended for use by loan agents and/or their supervisors to manage settings for the mobile borrower module 202 and/or the mobile lender module 204. Additionally, the mobile lending website module 206 may be used as well as to access loan applications and other forms and documents submitted from those modules.

The backend applications module 208 is a set of applications to process data and data transactions between all of the system components. As illustrated, it may be implemented as a computing cloud. However, it will be understood it may be implemented using any conventional technique, such as providing support on one or more servers.

The mobile lending service 200 streamlines the mortgage loan application process and reduces it to a few steps by eliminating the use of paper by introducing electronic versions of the mortgage forms within a set of tablet applications. The mortgage industry utilizes a standard set of forms. These standard forms may be produced in tablet form, having identical fields as the standard paper forms. Thus, there is no learning curve. In tablet form, individual fields may be accessed and the data entered directly. Because tablet computers have touch screens, a user has several options to enter a signature. This includes signing or initialing forms using their finger or a stylus.

Instead of filling out a set of paper forms, borrowers can now access them, in an identical form, either on their own tablet computer or the tablet computer of their loan agent. Borrowers can type in and save form data directly on their tablet computing device 254. They can sign and initial all appropriate spots by hand or with a stylus.

In one embodiment, additional documentation necessary for the loan application can be photographed (and added to the electronic loan file) by using the tablet computer's camera 280. Examples of additional documentation that might be photographed include W-2 forms, tax returns, paystubs, and driver's licenses. Borrowers can submit the appropriate forms to their loan agent. The submitted data and signatures are validated based on the specific form's requirements. The signed documents and data are imported into the servers of the mobile lending service 200 and are available to access from the mobile lending website.

Signed documents may be saved and submitted in a variety of ways known in the art. For example, a true graphical representation of the complete document may be saved and/or submitted. Alternatively, compressed forms of the document may be saved or sent. Additionally, individual data fields may be saved and/or submitted with appropriate pointers or other identifying information to reconstruct the relevant loan document at other locations.

Loan agents have the choice to setup an automatic transfer of data and document images to their LOS system 250 whenever a loan application and/or other forms are submitted from their tablet computing device 256. In one embodiment, all data on the tablet applications is protected by a personal code that is set up when these applications are installed, and is required every time the applications are accessed. All public network communications between the various components of the mobile lending service 200 are implemented over SSL connections.

The mobile lending service 200 provides numerous advantages. Conventionally, applying for a loan is a time consuming process requiring that many pieces of paper be initialed, signed, copied, and submitted to a LOS. In contrast, the mobile lending service 200 permits electronic versions of all of the loan documents to be displayed on a mobile device, the data fields entered, the borrower to make all of the necessary initials and signatures, and also permits (via the camera) the loading of other documents used to support a loan, such as bank statements or other documents providing evidence of sources of income or funds.

Additionally, the security of the borrower's information is maintained at all steps of the process. The signed forms and data are securely transferred from the tablet computers to the loan agent's LOS software and imaging system. Private data is stored securely on the tablet computers and is never transferred in unsecured ways therefore eliminating the risk of exposure to the Internet. In particular, the degree of security is much higher than if information was sent by email.

### II. Detailed Example of Mobile Lending Module (“Borrowermobile”)

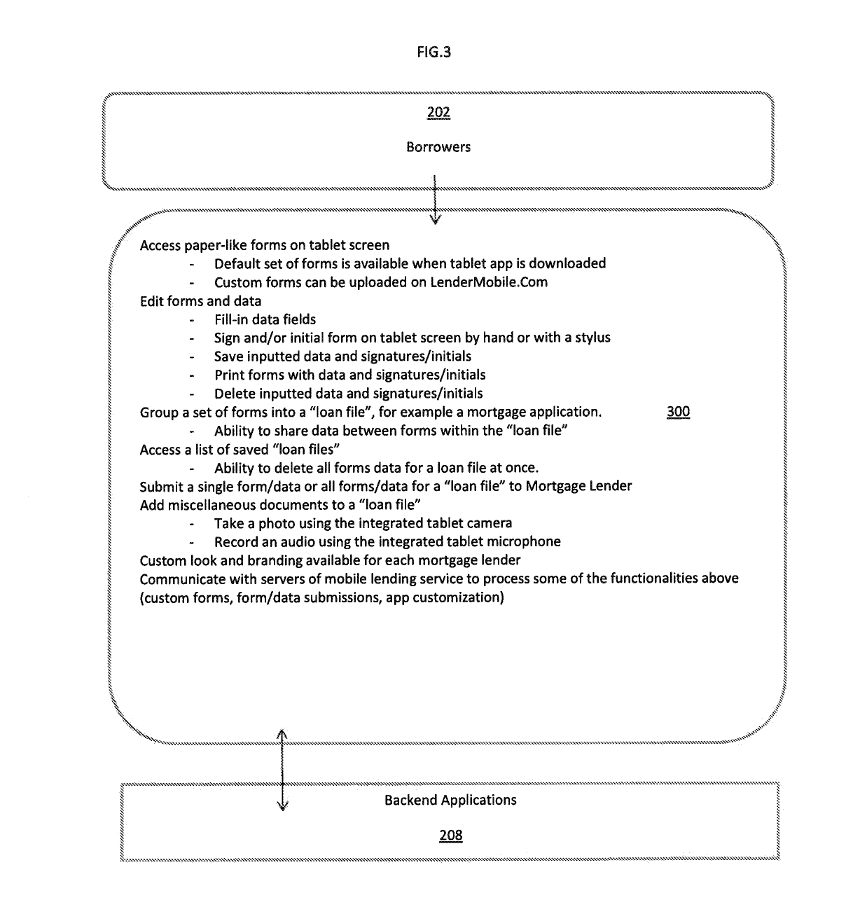

The mobile borrower module 202 is an application software intended for use by borrowers to apply for a mortgage loan from their tablet computer, as well as to check the status of their application, and to submit and review documents associated with that application. FIG. 3 illustrates an exemplary set of functionalities 300 for the mobile borrower 202. These include various functionalities that allow the borrower to fill-in, sign and submit a mortgage loan application, and other mortgage forms and documents from their tablet computer. These include accessing paper-like forms on a tablet screen, editing forms and data, grouping a set of forms into a loan file, accessing a list of saved loan files, submitting all or part of a loan file to a mortgage file, adding miscellaneous documents to a loan file, defining a custom look and branding for the mortgage lender, and communicating with the servers of the mobile lending service to process some of the functionalities.

In one embodiment, the borrower downloads and installs the application on their tablet computer and is asked to provide their email address and to create a personal code when opening the application for a first time. An email is then sent to the borrower's email address with a unique link to the mobile lending service's website. The borrower needs to follow the link to confirm that he/she is the owner of that email address before they get granted access to the mobile app. Every subsequent opening of the application will require the borrower to input their personal code to ensure that private data is secured.

The mobile borrower module 202 is dynamically linked to a specific mortgage broker or lender. This linkage ensures that the application is enabled to submit forms to the appropriate lender or broker, the company information and logo of the appropriate lender or broker are downloaded to the application, all custom disclosures for the appropriate lender or broker are downloaded to the application.

Borrowers have the option to start a new loan file or to access a list of loan files already started, and from there, to access the forms and documents associated with each one. Every loan file includes a set of mortgage documents. Each mortgage document is presented on the tablet screen in an identical form as its paper counterpart. This is achieved by displaying an image of the blank document on the screen, and then, drawing the data input fields on top of that. The borrowers can fill in data by using the tablet touch screen functionality. Data input in a particular field can be overwritten or removed. A “write-in” box is displayed by tapping on a signature or initials area on the form. Borrowers can use their hand or a stylus to sign or initial within the box, and have the choice to accept or cancel the operation. The accepted signature and/or initials are immediately displayed in the appropriate area on the form. At any point, borrowers are able to save the input data and signatures or delete the loan file all together.

Data input on the forms is stored in custom database files on the tablet device. Some of the data input for a specific document may be shared with other documents within the same loan file. For example, the name of the borrower may be shared on many of the mortgage documents, and inputting it on one of the documents will automatically make it appear on the other documents as well. Signatures and initials are stored in image files on the tablet device.

Once a loan file has been started, the borrower has access to a list of items that need to be completed for that particular loan (“to do list”). This list is generated by the loan agent by using their LOS or on the mobile lending website. When a new item is added to the list, the borrower receives an instant notification message on their device. Within the list, the borrower has different options on how to complete a particular item based on its type. An example of the types of items that can be added to the list include:
1) a request to provide a photo copy of a borrower document, for example, a driver's license. To complete this item, the borrower can use the camera of their mobile device to take a picture and then use the mobile borrower application to submit the picture back to the loan agent;
2) a request to review a document submitted by the loan agent. In this case the borrower simply opens the document from within the application to mark the item as completed;
3) a request to fill-in and/or sign a particular document submitted by the loan agent. To complete this item, the borrower opens the document from within the application, fills in all required fields if any, signs the document if requested and submits it back to the loan agent; and
4) a calendar reminder of a future event at a specific date and time. To complete this item, the borrower adds the event to the calendar application included with their device.

Whenever the borrower completes a particular item, the item is removed from the “to do list” and moved into an archive section of the application. At the same time the loan agent is notified that the item has been completed and any appropriate documents are forwarded to the agent.

At any point after a loan file is created, the borrowers have the option to submit all forms and data for that file to their mortgage lender or mortgage broker. When they do that, all data and image files are transferred from the tablet device to the servers of the mobile lending service over SSL encrypted connection. The data and images are processed by Backend Applications on the servers and a response is returned to the tablet either confirming that the transaction was successful or indicating a problem with the forms, data or transaction.

### III. Detailed Example of Mobile Lender Module (“Lendermobile+”)

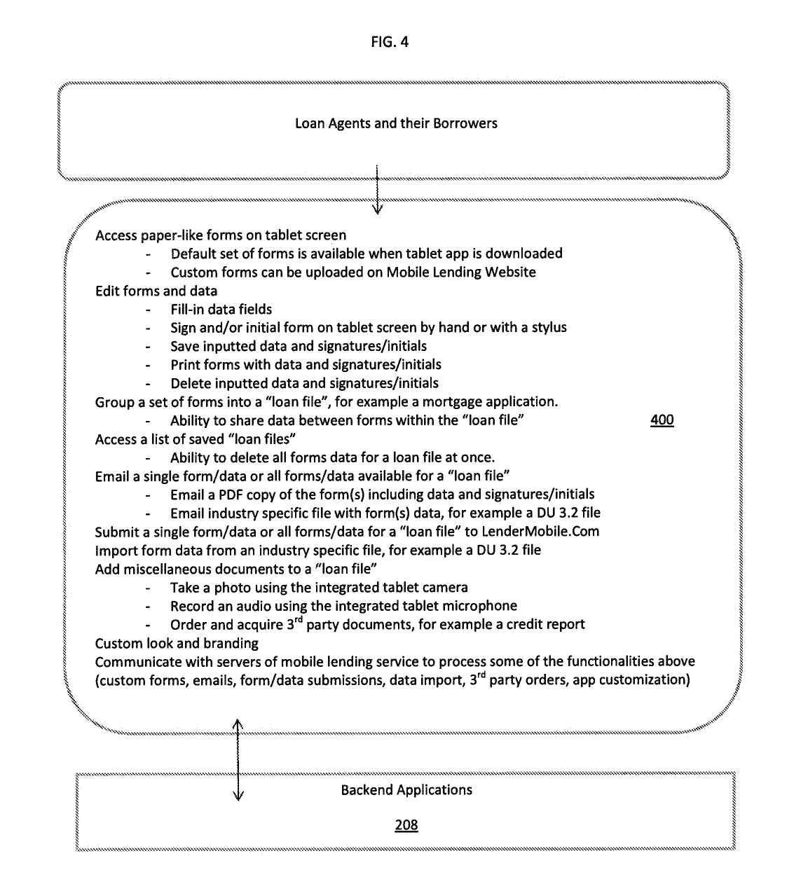

The mobile lender module 204 is application software intended for use by loan agents to take and process mortgage loan applications from their tablet computer. It includes various functionalities that allow the loan agent and/or borrowers to fill-in, sign and submit a mortgage loan application and other mortgage forms from a tablet computer. FIG. 4 illustrates an exemplary list of functionalities 400. These include accessing paper-like forms on a tablet screen, editing forms and data, grouping a set of forms into a loan file, accessing a list of saved loan files, emailing part or all of the forms or data of a loan file, importing data from an industry specific file, adding miscellaneous documents to a loan file, custom look and branding, and communicating with the mobile lending service serves to process some of the functionalities.

In one embodiment, the loan agent downloads and installs the application on a tablet computer and is asked to create a personal code when opening the application for a first time. Every subsequent opening of the application will require the loan agent to input that personal code to ensure that private data is secured.

The mobile lender module 204 is dynamically linked to a specific mortgage broker/lender company. Several things occur when this linkage is activated: the application is enabled to submit forms to the appropriate company, the company information and logo of the appropriate lender or broker are downloaded to the application, all custom disclosures for the appropriate company are downloaded to the application, the functionality to email PDF and DU 3.2 formatted files is enabled, and additional loan processing functionalities are enabled (for example, order vendor services, access LOS pipeline, etc.).

Loan agents have the option to start a new loan file or to access a list of loan files already started, and from there, to access the forms associated with each one. Every loan file includes a set of mortgage documents. Each mortgage document is presented on the tablet screen in an identical form as its paper counterpart. This is achieved by displaying an image of the blank document on the screen, and then drawing the data input fields on top of that. The loan agents can fill in data by using the tablet touch screen functionality. Data input in a particular field can be overwritten or removed. A “write-in” box is displayed by tapping on a signature or initials area on the form. Borrowers can use their hand or a stylus to sign or initial within the box and have the choice to accept or cancel the operation. The accepted signature and/or initials are immediately displayed in the appropriate area on the form. At any point, loan agents are able to save the input data and signatures or delete the loan file all together.

Data input on the forms is stored in custom text files on the tablet device. Some of the data input for a specific document may be shared with other documents within the same loan file. For example, the name of the borrower may be shared on many of the mortgage documents and inputting it on one of the documents will automatically make it appear on the other documents as well. Signatures and initials are stored in image files on the tablet device.

At any point after a loan file is created, the loan agents have the option to submit all forms and data for that file to their mortgage lender or mortgage broker, email some or all of the forms in a PDF or DU 3.2 formatted file, or perform additional loan processing tasks (for example, order a credit report). When they do any of that, all data and some or all image files are transferred from the tablet device to the servers of the mobile lending service over SSL encrypted connection. The data and images are processed by backend Applications on the servers and a response is returned to the tablet either confirming that the transaction was successful or indicating a problem with the forms, data or transaction.

A special “Invite” feature allows loan agents to link with a borrower who uses the mobile borrower application to allow for sharing of documents between the two applications.

### IV. Detailed Example of Backend Applications Module

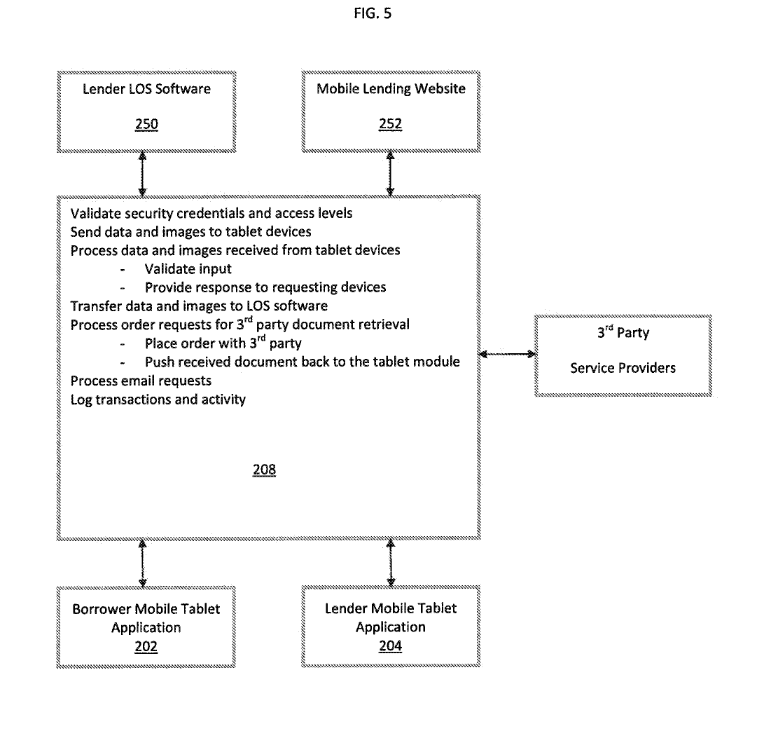

FIG. 5 illustrates some of the functions of the backend applications 208 in accordance with an embodiment of the present invention. An exemplary set of functions include validating security credentials and access layers, sending data and images to tablet devices, processing data and images received from tablet devices, transferring data and images to LOS software, processing order required for third party document retrieval, processing email requests, and logging transactions and activity.

The backend applications layer 208 is responsible for processing all data communications between the tablet modules, mobile lending service servers, and third party servers. Processing includes security validations, input validations, data and image file transfers between the various modules, as well as to third party servers.

The backend applications layer includes several applications and classes that reside on the servers of the mobile lending service, including the mobile lending website 206, as well as dedicated application layer servers. Some applications, such as those embedded in server-side code for web pages, are executed immediately when a request is received from a calling process, for example, a request to submit loan data. Other applications, such as email processing services are executed on a predefined schedule. Many of the applications make calls to an SQL database server to obtain or save data associated with their specific process. Some applications make calls to servers located outside the mobile lending service to complete one or more transactions associated with their specific process.

Mobile lending website pages are responsible for accepting secure connections initiated from tablet devices. Within these connections, account credentials are passed and checked against the mobile lender database, and if accepted, a secured channel is opened to allow the transfer of data and/or image files. Tablets connect to these website pages to validate user credentials, link tablet module accounts to accounts of the mobile lending service, download custom lender or broker information, logo and forms, download data and images associated with additional services being made available on the tablet, for example, credit report order results, and to upload data and image files.

Various input validations and calculations exist when data and image files are uploaded depending on the operation requested from the tablet computer. In some instances, uploaded forms are checked for correct completion, including the presence of signature and initials, or data entries in particular fields and error messages are returned back to the tablet modules if some data is found to be missing.

DU 3.2 file generation and parsing are also part of this module. When a request is received to generate and process a DU 3.2 file, the calling tablet module submits all data files associated with the particular loan file. The data files are saved on the server and a function is invoked on the web server to parse through these files and generate a new DU 3.2 file. Each applicable piece of data is read from the data files and is written to the new file at a specific position based on the DU 3.2 specifications. The reverse process also exists—create data files from a DU 3.2 file. In that process, a website user submits a DU 3.2 file to the web server. An application on the server then uses a pre-defined map to relate each data field from the DU 3.2 file to a specific data file and line number, and it writes the data to that file. A database tablet is then updated with the location of the newly created files and the tablet device ID of the associate user account. When a request is received from a tablet with the same device ID the server transfers the files to that device.

This layer is also responsible for managing the linkage between lenders, loan agents and borrowers, including support for the “Invite” functionality available in the mobile lender application.

The backend applications layer supports automatic data and image transfers to third party LOS systems for brokers and lenders who choose to do so. When a submission is received from a tablet device, the backend applications layer will attempt to connect to a third part LOS system's server using the credentials provided by the lender or broker. When such a connection is established, the application layer will use functionalities provided by the third party LOS systems to upload a DU 3.2 file and/or image files to that system. Alternatively, the application layer may download a DU 3.2 file and/or image files from the LOS systems.

In addition, this layer is responsible for processing requests associated with other services being offered to tablet users. For example, a loan agent may place a request for a credit report from the mobile lender module Upon receiving that request, the Backend Applications layer will connect to, and place an order with, a third party vendor, retrieve the report and make it available to the loan agent. Another example: a borrower or a loan agent may place a request from the tablet module to view current products and pricing for a particular lender. The layer will then query the database and will return the relevant information back to the requesting party.

When documents are requested to be emailed from the mobile lender app, the backend applications layer will save the documents on the servers of the mobile lending service, and will send an email containing a link to an SSL encrypted page of the mobile lending website that email recipients can access to download them. If requested by the tablet app user, an optional password is required to be provided by the website user before documents can be downloaded.

Logs of various processing activities and transactions are maintained by this module to assist with security monitoring, customer service, technical support, product enhancements and other uses. In many of the applications a log entry is written to the SQL database server each time an error occurs (either handled or unhandled).

### V. Detailed Example of Mobile Lending Web Site (“Lendermobile.com”) Module

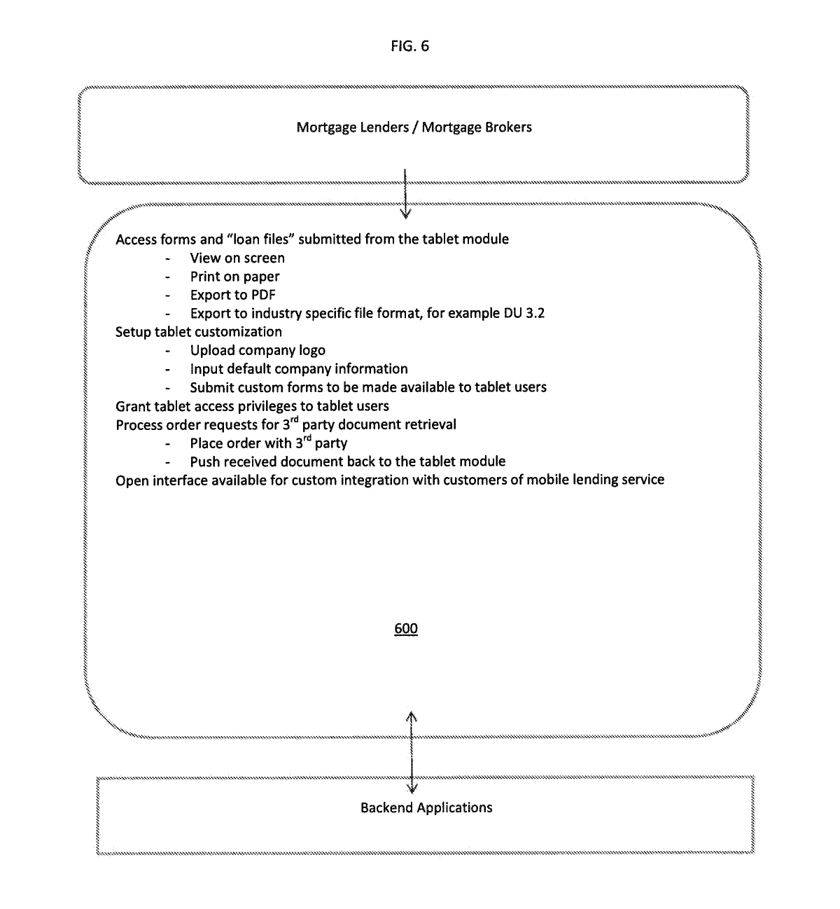

The mobile lending website (LenderMobile.com) module 206 of the mobile lending service 200 provides mortgage lenders and/or mortgage brokers with the ability to manage settings for the mobile borrower and mobile lender modules, as well as access loan applications and documents submitted from those modules. An exemplary set of functions 600 for mobile lending website module 206 is illustrated in FIG. 6. These include providing access to forms and loan files submitted from the mobile tablet applications, setting up table customization (e.g., custom forms, company default information and logo), granting access privileges to tablet device users, processing order requests for third party document retrieval, and providing an open interface for custom integration with the customers of the mobile lending service.

In one embodiment, registered website users have the ability to upload their company's custom logo and input their company's custom information in the way they want it to appear on the tablet computers. In one embodiment, mortgage lenders and/or mortgage brokers can upload custom forms and documents that they want to make available to their tablet users. In one implementation, after the custom logo is received on servers of the mobile lending service 200, it is manually processed and formatted for the tablet modules. Custom forms may also be processed manually. As an example, an image of blank forms may be created, data input fields are set in the tablet module's configuration files, and database records are created for the forms for the particular lender or broker.

When users link their tablet's mobile tablet modules with a particular mortgage lender or mortgage broker account, all custom information, custom logo and custom forms are downloaded to the user's tablet application module.

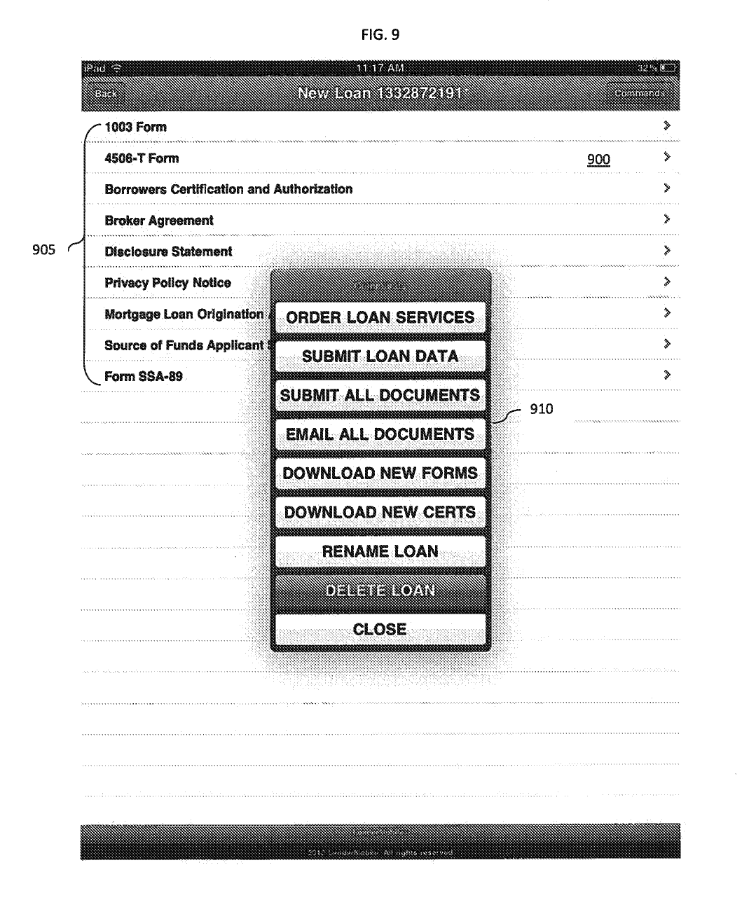

In one embodiment, the mobile lending website also provides mortgage lenders and mortgage brokers with the ability to control who has access to link a tablet module with their account. Through the mobile lender access screen (illustrated in FIG. 9), mortgage lenders and/or mortgage brokers can specify a list of email addresses for loan agents that are allowed access to link a mobile lender tablet module to their accounts.

In one embodiment, mortgage lenders and/or brokers have the ability to specify if they want data and images transferred automatically to a third party LOS system upon submission from a tablet module. When this flag is turned on, the backend applications layer will attempt to automatically connect to the third party LOS system and upload submitted data and image files to the particular user's account in that system.

Registered website users have the ability to maintain and configure other services they want to make available to their tablet module users, two examples being credit report ordering and product and rates pricing matrix.

In one embodiment, the mobile lending website (LenderMobile.com) has a loans section that allows registered website users to access loan files submitted from the mobile borrower tablet module 202 or mobile lender tablet module 204. For each loan file, users can download a DU 3.2 formatted data file that can be used to manually upload the data to a third party LOS system.

In one embodiment, access to an imaging system module (not shown) is provided for each loan file as well. Within the imaging system, users can access PDF formatted files and images of documents previously submitted from the tablet modules. In one implementation, PDF files and images are categorized based on the document type they appeared under on the tablet module. Each additional submission for a particular document type for a particular loan file will add an additional image or PDF record under the corresponding document type category within the image system. Users can view, download and print a single document or all documents associated with a particular loan file.

In one embodiment, loan agents can use the mobile lending web site's (LenderMobile.com) portal to manage the “to do list” for borrowers using the mobile borrower tablet module 202. From the website, agents can add new “to do list” items and review documentation and action log for existing ones.

### VI. Graphical User Interface Examples

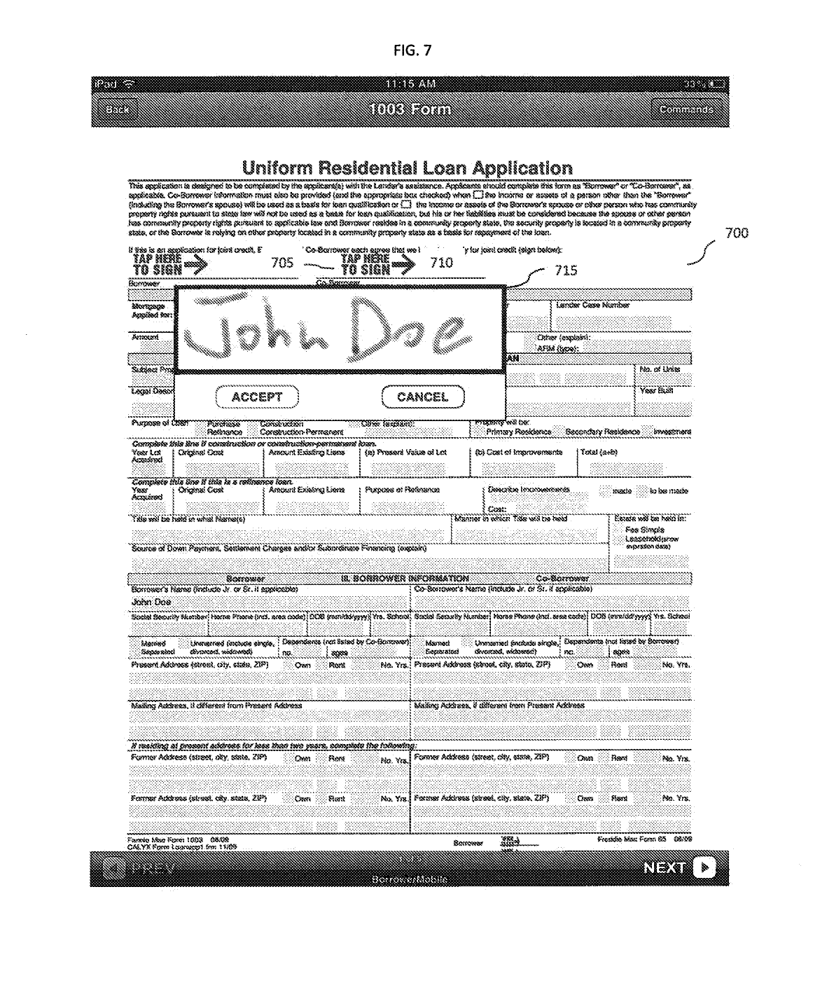

FIG. 7 is a screen display illustrating how a loan form application 700 may be displayed on the touchscreen of a mobile device, such as a tablet computer. In this example, a uniform residential loan application (“1003 form”) is displayed. In this example, the form is displayed to be identical to a paper version of the 1003 form, with a few minor exceptions, such as having a “tap here to sign” indicator 705 next to a signature field 710. The form displayed on the tablet computer includes active fields 720 to enter and/or correct loan application information. In this example, the new loan application has completely blank fields.

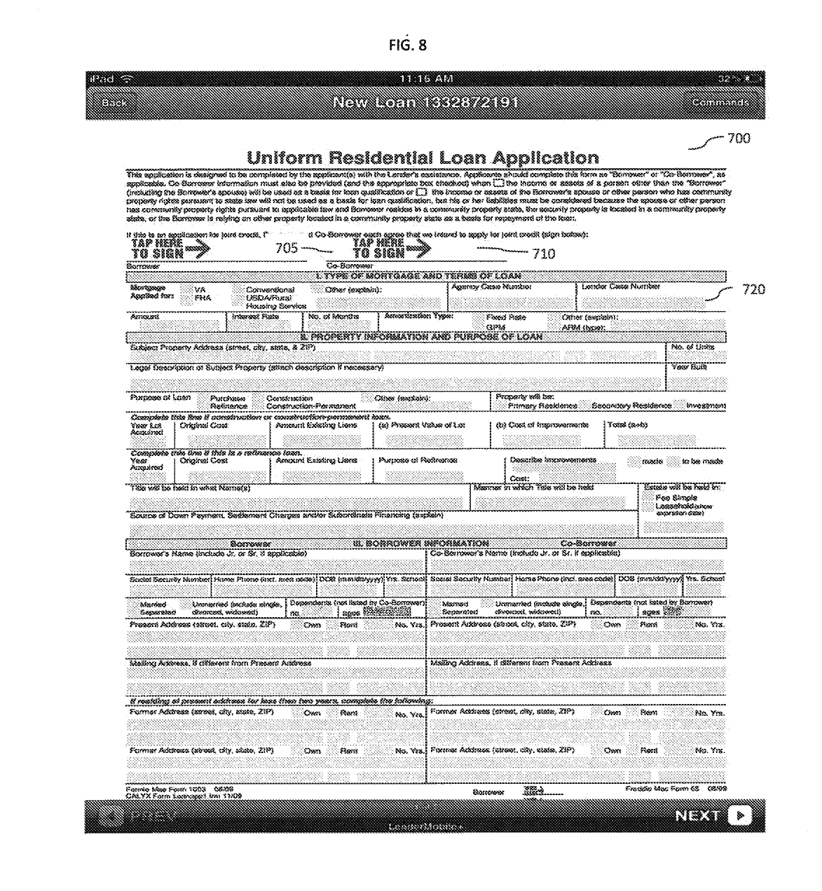

As illustrated in FIG. 8, in one embodiment of a graphical user interface for a touchscreen device, a user may tap onto a signature field. A signature box 715 is then displayed for the user to trace their signature with their finger and then enter the signature, e.g., with an accept button. In this example, the user has the loan application displayed to them on the mobile device and the user enters their signature via the touchscreen. Note that the signature field 715 may be displayed with larger size to make entering a signature with a finger or stylus convenient for the user. Additionally, while a signature field 715 is illustrated showing a full signature entered, more generally initials can also be entered for those loan forms requiring specific pages to be initialed. Additionally, more than one signature can be entered in separate fields, such as borrower and co-borrower signatures.

FIG. 9 illustrates a user interface 900 for a touchscreen device displaying an exemplary set of commands 910 and form options 905. In one embodiment, a complete set of common loan form documents is provided for the user to select from to display and/or fill in via a mobile device, such as a 1003 form, 4506-T form, borrowers' certification and authorization, broker agreement, disclosure statement, privacy policy notice, mortgage loan origination, Applicant's source of funds, and form SSA-89. An exemplary set of commands includes: order loan services, submit loan data, submit all documents, email all documents, download new forms, download new certifications (certs), rename loan, delete loan, and close.

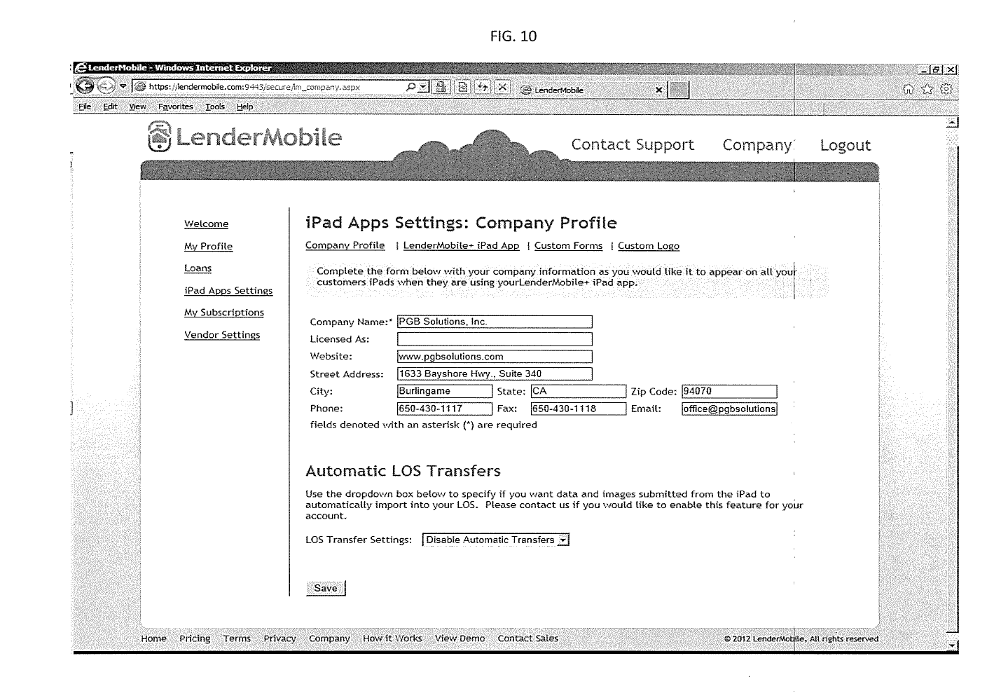

FIG. 10 illustrates a graphical user interface for a mobile device application setting page. In this example, a loan company can input company information on how they would like company information to appear on a customer's tablet computer (e.g., an iPad™).

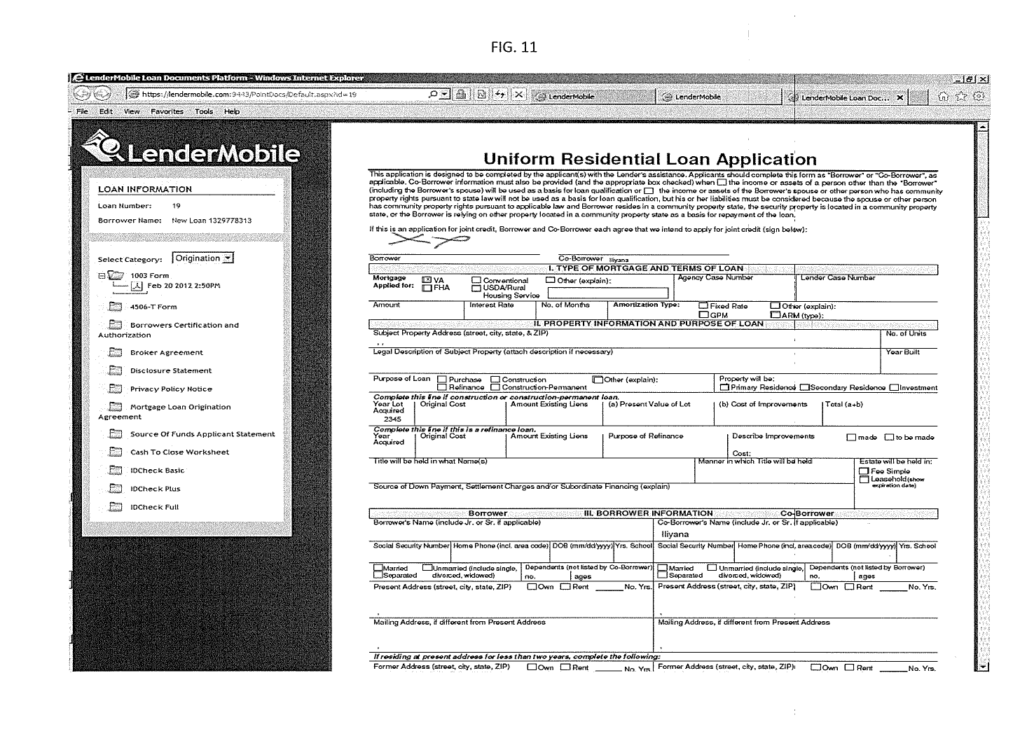

FIG. 11 is a snapshot illustrating how a loan form and accompanying documents appear to loan agent using a web interface to the portal of the mobile lending website. In this example, a set of folders for an individual loan application appears on the right. In this example, the folders include a 1003 form, 4506-T form, borrower's certification and authorization, broker agreement, disclosure statement, privacy policy notice, mortgage loan origination agreement, source of funds applicant statement, cash to close worksheet, and ID checks. A loan agent can select and display/print individual forms from loan file. Loan agents can use a lending portal of the mobile lending website (the LenderMobile.com portal) to manage the “to do list” for borrowers using the mobile borrower module 202. From the website agents can add new “to do list” items and review documentation and action log for existing ones.

### VII. Use Example

As previously discussed, the present invention can be used in ways that permit paperless loan applications and which greatly increase the speed and efficiency of the loan application process.

The following typical use example demonstrates one possible scenario for taking and processing a loan application by using the current invention.

At some initial time, a loan company (or other loan entity) sets up the logos and other information they want displayed on a tablet application besides the standards set of loan forms. Additionally, the loan company specifies loan agents that have access.

A loan agent meets with a borrower at the borrower's private residence and brings along a tablet computer with the mobile lender tablet application 204 installed.

The loan agent interviews the borrower and inputs the borrower's answers in the mobile lender tablet computer application.

The borrower signs the loan application and a borrower certification and authorization form (necessary to authorize the loan agent to order a credit report on borrower's behalf) on the tablet computer (in the mobile lender application).

From the mobile lender tablet computer app 204, the loan agent orders a credit report for the borrower. At this time, all data and images are submitted to a mobile lender server, where they are processed and a credit order is placed with a credit agency. Within seconds, the credit order is returned back to the mobile lender server and from there it is returned back to the loan agent. The credit report is displayed to the loan agent and borrower on the tablet computer (in the mobile lender application).

Using data from the credit report, the loan agent requests from within the mobile lender loan application a product and price list for this particular loan application. The request is sent to a mobile lender server where a subsequent request is placed to the loan agent's product and pricing matrix vendor. The data returned from that vendor is pushed back to the tablet computer and is made available to the loan agent and borrower in the mobile lender application 204.

The borrower decides on a loan product and rate, the loan agent inputs the borrower's choice and submits all loan application forms and data to the loan agent's LOS. At this time, all data and images for this loan are transferred to a mobile lender server. The mobile lender server then forwards these items to the loan agent's LOS.

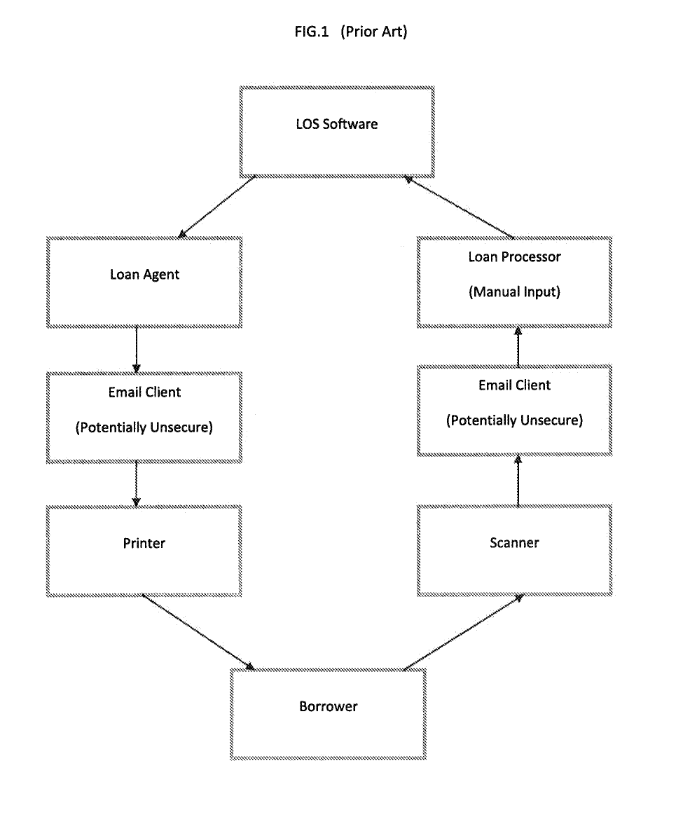

By way of contrast, consider a prior art approach as illustrated in FIG. 1. In the prior art, a loan agent would provide paper loan application forms, along with other custom mortgage disclosures and provide these to the borrower. Some or all paper forms are either blank or have data pre-printed on them. The borrower would have to sign these documents and return them to the loan agent. Once the loan agent received the signed documents, he would have to process them and make sure the loan data exists in his LOS and that the signed documents are stored in his imaging system. If the data was filled-in by the borrower on the loan application and/or other forms, the loan agent would have to manually input this data in his LOS or use a computer scanner to convert them to such. In all cases, the loan agent would have to manually import the electronic document in his imaging system. Thus, in the prior art there are numerous inefficient steps.

Thus, in this example, it can be seen that present invention provides a tremendous increase in efficiency over the prior art by creating a truly paperless solution for taking and processing a loan application.

### ALTERNATE EMBODIMENTS

The solution described above relates to significant improvements to the process of taking a mortgage loan application through utilizing modern technologies, including tablet computers, servers, and the Internet, to eliminate the need to use paper in that process. While the scope of this document is to describe that particular solution, the same process can be used to solve similar problems in many other areas. The current invention, therefore, can be applied to any other process that currently utilizes a paper document to obtain data along with signatures and/or initials from a person and submit that document to another person or entity for any purpose. It's nearly impossible to list all of the potential processes that can benefit from this invention. Two examples are listed below.

### Other Use Example 1

Attorneys require their clients to sign an “attorney-client” agreement before they can initiate any consultations. Currently, in some cases, attorneys will email the agreement which their potential clients will have to print, sign, scan, and email back. By utilizing the process described in the current invention, Attorneys can direct their clients to a tablet application where they can fill in, sign and submit the appropriate documents without using any paper and effectively saving the print, sign and scan steps.

### Other Use Example 2

Sometimes in order for two businesses to begin a relationship they need to sign a mutual non-disclosure agreement. Currently, in some cases, one of the companies will email the agreement to the other for its representative to print, sign, scan, and email back. By utilizing the process described in the current invention, the initiating company can direct their potential partner company to a tablet application where they can fill-in, sign and submit the appropriate documents without using any paper and effectively saving the print, sign and scan steps.

### DEFINITIONS

Tablet Computer (also tablet device or tablet computing device): A tablet computer, or a tablet, is a mobile computer with at least one processor and memory, larger than a mobile phone or personal digital assistant, integrated into a flat touch screen and primarily operated by touching the screen rather than using a physical keyboard. It often uses an onscreen virtual keyboard, a passive stylus pen, or a digital pen. There are also tablet computers having different screen sizes.

The term tablet computer may also apply to a variety of form factors that differ in position of the screen with respect to a keyboard. The standard form is called slate, which does not have an integrated keyboard, but may be connected to one with a wireless link or a USB port. There are also convertible notebook computers that have an integrated keyboard that can be hidden by a swivel joint or slide joint, exposing only the screen for touch operation. Hybrids have a detachable keyboard so that the touch screen can be used as a stand-alone tablet. Booklets include two touch screens, and can be used as a notebook by displaying a virtual keyboard in one of them. A tablet also may have a wireless network adapter allowing the device to connect to other computers in a local network or to the Internet.

For the purpose of this invention, the definition of a tablet computing device may also represent any similar hardware that may be available to the public in the future. As an example, it will also be understood that the computing industry is making rapid advances in create virtual displays (e.g., using glasses to display a graphical user interface). Thus, at some time in the future it can be expected that the same functionality of a tablet compute with a touchscreen device might be implemented via other means, which would be a functional equivalent of a touch screen tablet computer in regards to presenting a graphical user interface and permitting a user to interact with the user interface and enter a signature via movement of the user's finger.

Server Computer (also server): A server is a physical computer (a computer hardware system) with at least one processor and memory dedicated to running one or more software application services (as a host), to serve the needs of users of other computers on the network. Depending on the computing service that it offers, it could be a database server, file server, mail server, print server, web server, or some other kind of server. Servers often provide essential services across a network, either to private users inside a large organization or to public users via the Internet.

DU 3.2 file format: A proprietary file format for loan origination data found on the Uniform Residential Loan Application (Fannie Mae Form 1003 Version 3.2), and other data needed to specify conforming loans, government loans, and loans eligible for Fannie Mae Community Lending. The data contained in such files is for a variety of business transactions including loan origination, underwriting and credit submissions.

4506-T Form: A form to request a copy of a tax return from the Internal Revenue Service.

1003 Form: A Uniform Residential Loan Application Form

Form SSA-89: An Authorization Request for the Social Security Administration (SSA) To Release A Social Security Number (SSN) Verification.

While the invention has been described in conjunction with specific embodiments, it will be understood that it is not intended to limit the invention to the described embodiments. On the contrary, it is intended to cover alternatives, modifications, and equivalents as may be included within the spirit and scope of the invention as defined by the appended claims. The present invention may be practiced without some or all of these specific details. In addition, well known features may not have been described in detail to avoid unnecessarily obscuring the invention.

In accordance with the present invention, the components, process steps, and/or data structures may be implemented using various types of operating systems, programming languages, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. The present invention may also be tangibly embodied as a set of computer instructions stored on a computer readable medium, such as a memory device.

What is claimed is:

1. A method of taking and processing paperless mortgage loan applications via a mobile device, comprising:
displaying, on a touch screen of a mobile computing device, a loan document having loan data input fields and at least one signature field for a loan applicant to enter at least one of a full signature and initials; and
receiving user inputs of the loan applicant to the loan document entered via the mobile computing device, the user inputs including at least one entry to a signature field entered via the touch screen.

2. The method of claim 1, wherein the mobile computing device is a tablet computing device.

3. The method of claim 1, further comprising displaying a command on the touch screen including at least one of ordering loan services, submitting loan data, submitting all loan documents, emailing all loan documents, downloading new forms, downloading new certifications, renaming a loan, and deleting a loan.

4. The method of claim 1, further comprising securely submitting at least the entries of the completed loan document to a mortgage lender.

5. The method of claim 4, wherein at least the data entries of the loan document is securely submitted to a Loan Origination System (LOS).

6. The method of claim 1, further comprising reviewing the loan file from the mobile computing device.

7. The method of claim 1, further comprising sending the loan file to a mobile lending service for review of the loan file from a web portal associated with the mobile lending service.

8. The method of claim 1, receiving, via a camera of the mobile computing device, a picture of a document related to a loan application and storing the document with the loan file.

9. The method of claim 1, wherein the loan document is one of a 1003 Form, a 4506-T Form, a Borrowers Certification and Authorization, a Broker Agreement, a Disclosure Statement, a Privacy Policy Notice, a Mortgage Loan Origination Application, a Source of Funds Applicant Sources, and a Form SSA-89.

10. The method of claim 1, further comprising storing the completed loan document in a loan file in a memory of the mobile computing device at least until the completed loan document is submitted.

11. The method of claim 1, further comprising submitting credit report application information via the mobile tablet device and receiving a credit report.

12. A computer program product comprising a non-transitory computer readable medium having computer to execute on at least one processor any of the methods of claims 1-11.

13. A method of providing a paperless loan application service, comprising:
providing a web portal for mortgage lenders to define individuals authorized to have access to a mobile tablet software application for entering and reviewing loan information via mobile tablet computing devices;
providing access to the mobile tablet application to an authorized user, the mobile tablet application generating a display on a touch screen of a mobile tablet computing device of a loan document having data entry fields and at least one signature field for entering at least one of initials and a signature;
receiving from the mobile tablet computing device the data entries and signature for a completed loan document; and
providing the completed loan document to at least one of a mortgage lender and a lender origination system.

14. The method of claim 13, further comprising providing images of the loan documents via the web portal.

15. The method of claim 13, wherein the completed loan document is a credit information document and the method further comprises submitting the credit information to a credit report agency and returning the result of a credit report to the mobile device.

16. The method of claim 13, further comprising providing customization of at least one aspect of the display of the mobile tablet application in response to a request from a mortgage lender.

17. The method of claim 13, further comprising checking submitted loan documents to confirm completeness.

18. A method of taking a paperless mortgage loan application, comprising:
generating a graphical user interface on a touchscreen tablet computer, the graphical user interface including user interfaces for a set of loan documents of a mortgage loan for a borrower to execute all necessary signatures, with at least one loan document including data entry fields and at least one field to enter a signature authorization via the touchscreen;
wherein the graphical user interface provides complete set of mortgage loan application documents is provided for the borrower to enter all necessary signatures or initials via the touchscreen tablet computer such that the entire loan application process is paperless.

19. The method of claim 18, wherein the loan documents include at least one of a 1003 Form, a 4506-T Form, a Borrowers Certification and Authorization, a Broker Agreement, a Disclosure Statement, a Privacy Policy Notice, a Mortgage Loan Origination Application, a Source of Funds Applicant Sources, and a Form SSA-89.

20. The method of claim 18, wherein the graphical user interfaces include a complete set of loan documents for a borrower to review and execute all documents for a mortgage loan application.
